(19) United States
(12) Patent Application Publication
(10) Pub. No.: US 2013/0019779 A1
(43) Pub. Date: Jan. 24, 2013

(54) ADMIXTURE FOR A HYDRAULIC COMPOSITION

(71) Applicants: Sébastien Georges, Mions (FR); Emmanuel Villard, Saint-Christo-en-Jarez (FR); Martin Mosquet, Bourgoin-Jallieu (FR); Emmanuel Faure, Lyon (FR)

(72) Inventors: Sébastien Georges, Mions (FR); Emmanuel Villard, Saint-Christo-en-Jarez (FR); Martin Mosquet, Bourgoin-Jallieu (FR); Emmanuel Faure, Lyon (FR)

(73) Assignee: LAFARGE, Paris (FR)

(21) Appl. No.: 13/521,508

(22) PCT Filed: Jan. 10, 2011
(86) PCT No.: PCT/FR2011/050031

§ 371 Date: Aug. 13, 2012

(30) Foreign Application Priority Data
Jan. 15, 2010 (FR) PCT/FR2010/000031

(51) Int. Cl. C04B 40/00

(52) U.S. Cl. 106/708; 524/4

(57) ABSTRACT

A method includes using, as an inerting agent of carbonaceous materials, for treatment of at least one constituent of a hydraulic composition comprising at least one air-entraining agent, the constituent including the carbonaceous materials, of an admixture, including at least one polymer comprising at least one chain having hydrophobic end groups and an intermediary hydrophilic group between the end groups, the admixture being adapted to at least partially neutralise the carbonaceous materials.

### FIELD OF THE INVENTION

The present invention relates to admixtures for hydraulic compositions and more particularly admixtures for treatment of carbonaceous materials, in particular active carbon or unburned carbon present in the hydraulic compositions.

### TECHNICAL BACKGROUND

In order to reduce emissions of carbon dioxide resulting from the production process of clinker, the current trend is to reduce the quantity of clinker in a concrete. One possibility consists of at least partially replacing part of the clinker by a cement addition or adding a cement addition to the clinker. An example of a cement addition corresponds to fly ash, which are waste materials produced by coal power stations.

Certain countries impose a reduction of emissions of heavy metals, in particular mercury, in coal power stations. With this aim, active carbon may be injected to trap the heavy metals while the power plant is in operation and these may be found in the waste material produced by the plant, for example fly ash. Active carbon may then be found in the fly ash used as a cement addition. One disadvantage is that active carbon modifies the action of certain admixtures used in concretes, in particular the air-entraining agents.

An air-entraining agent is an admixture which makes it possible to increase the quantity of entrained air in a concrete during the production of the concrete. The air-entraining agent is for example as defined in the NF EN 934-2 Standard, <<Admixture for concrete, mortar and slurry—Part 2: Admixtures for concrete—Definitions, specifications, conformity, marking and labelling>>. The presence of active carbon tends to reduce the efficiency of the air-entraining agent. More generally, the presence of carbonaceous materials, in particular active carbon or unburned carbon in fly ash, tends to reduce the efficiency of the air-entraining agent of a hydraulic composition.

One difficulty comes from the fact that the quantity and the type of active carbon are generally very variable from one type of fly ash to another and they may greatly vary for a same type of fly ash. It is therefore not possible to predict the evolution of the efficiency of an air-entraining agent when using a new batch of fly ash for the production of a concrete.

Furthermore, it is possible that a reduction of emissions of heavy metals, in particular mercury, will be imposed on cement plants that produce clinker. It would then be possible to use active carbon to trap the heavy metals and be found in the clinker produced by the cement plant or in the dusts of a cement kiln. The presence of active carbon would then tend to reduce the efficiency of an air-entraining agent present in the concrete produced using clinker.

Patent applications WO2004067471 and WO2007084794 describe admixtures for fly ash making it possible to at least partially neutralize the deleterious effects due to the presence of fly ash used for the production of concrete.

However, even though the initial content of entrained air in a concrete comprising an air-entraining agent and fly ash is increased by using at least certain admixtures described in these patent applications, it would appear that the air content tends to decrease over time resulting in that the final air content of the hardened concrete could be insufficient.

There is therefore a need for an admixture for a hydraulic composition comprising an air-entraining agent and carbonaceous materials, in particular active carbon or unburned carbon, which at least partially neutralizes the deleterious effects due to the presence of the carbonaceous materials in the hydraulic composition and the use of which results in a stable air content of the hydraulic composition over time.

### SUMMARY OF THE INVENTION

The invention relates to the use, as an inerting agent of carbonaceous materials, for treatment of at least one constituent of a hydraulic composition comprising at least one air-entraining agent, the said constituent comprising the carbonaceous materials, of an admixture, comprising at least one polymer comprising at least one chain having hydrophobic end groups and an intermediary hydrophilic group between the end groups, the admixture being adapted to at least partially neutralise the carbonaceous materials.

The admixture according to the invention has the following advantages:
by adding the admixture according to the invention, the obtained hydraulic composition has an initial air content close to the initial air content which would be obtained in the absence of carbonaceous materials;
the air content of the hydraulic composition decreases little over time; and
in the absence of carbonaceous materials, the admixture does not entrain or entrains little supplementary air compared to the air-entraining agent.

Advantageously, the admixture according to the invention further makes it possible to not modify the properties of the hydraulic composition, for example fluidity.

The term <<hydraulic composition>> is to be understood according to the present invention as a composition with a hydraulic set and, in particular, slurries, mortars and concretes intended for all the construction markets (buildings, civil engineering, bore wells or pre-cast plants).

The expression <<hydraulic binder>> is to be understood according to the present invention as a pulverulent material, which, mixed with water, forms a paste which sets and hardens as a result of hydration reactions. The hydraulic binder may be Portland cement.

The term <<concrete>>, is to be understood as a mix of hydraulic binders, aggregates, water, optionally admixtures, and optionally mineral additions, for example high performance concrete, very high performance concrete, self-placing concrete, self-levelling concrete, self-compacting concrete, roller-compacted concrete, fibre concrete, ready-mix concrete or coloured concrete. The term <<concrete>>, is also to be understood as concretes having been submitted to a finishing operation, for example bush-hammered concrete, exposed or washed concrete or polished concrete. Pre-stressed concrete is also to be understood by this definition. The term <<concrete>> comprises mortars. In this specific case, the concrete comprises a mix of hydraulic binder, sand, water and optionally admixtures and optionally mineral additions. The term <<concrete>> according to the invention denotes without distinction fresh concrete or hardened concrete.

The term <<aggregates>> is to be understood according to the invention as gravel, coarse gravel and/or sand.

The expression <<Portland cement>>, is to be understood according to the invention as a cement of type CEM I, CEM II, CEM III, OEM IV or CEM V according to the NF EN 197-1 <<Cement>> Standard.

The term <<fly ash>> is to be understood according to the present invention as a material obtained by electrostatic or mechanical precipitation of pulverulent particles contained in the smoke of boilers fed with pulverized coal (refer to the EN 197-1 Standard, paragraph 5.2.4).

The expression <<carbonaceous materials>> is to be understood as any carbonaceous material capable of at least partially adsorbing an air-entraining agent in a hydraulic composition. In particular, it may be unburned carbon of fly ash or active carbon.

The term <<active carbon>> or <<activated carbon>> is to be understood as a material in the form of a powder, consisting essentially of carbonaceous material with a microporous structure.

The expression <<inertant>> or <<inerting agent>> is to be understood as a compound adapted to at least partially neutralise the deleterious effects of carbonaceous materials on the hydraulic composition, in particular adapted to block the adsorption of the air-entraining agent by the carbonaceous materials. The inerting agent may also be called a sacrificial agent.

The expression <<probe molecules>> is to be understood as molecules which may be detected when they are present in solution and which may be adsorbed by the carbonaceous materials.

The term <<copolymer>> is to be understood as polymers obtained by polymerisation of several monomers of at least two different types.

The term <<hydrophobic group>> is to be understood as a group having a negative contribution in the calculation of the HLB according to the theory of Davies (J. T. Davies, Proc. Intern. Congr. Surface Active Substances, 2nd, London, Vol. I, p. 426 (1957)).

The term <<hydrophilic group>> is to be understood as a group having a positive contribution in the calculation of the HLB according to the theory of Davies.

The values of HLB may, for example be the following:

| | HLB according to |
|---|---|
| Groups | theory of Davies |
| —OSO₃ Na | +38.7 |
| —COOK | +21.1 |
| —COO Na | +19.1 |
| —N ternary amine | +9.4 |
| Ester (sorbitan) | +6.8 |
| Ester (free) | +2.4 |
| —COOH | +2.1 |
| —OH (free) | +1.9 |
| —O— | +1.3 |
| —OH (sorbitan) | +0.5 |
| —CH₂—CH₂—O— (ethylene oxide group) | +0.33 |
| —CH(CH₃)—CH₂—O— (propylene oxide group) | −0.015 |
| —CH₃, —CH₂—, ═CH— | −0.475 |

The admixture according to the invention tends to at least partially neutralize the carbonaceous materials, in particular the active carbon or the unburned carbon. One explanation would be that the polymer's hydrophobic groups are adsorbed on the surface of the carbonaceous materials resulting in the hydrophilic group, intermediary between the hydrophobic groups, spreading over the surface of the carbonaceous materials and contributes to:
reducing the anti-foaming properties of the carbonaceous materials; and
preventing the adsorption of the air-entraining agent by the carbonaceous materials.

The admixture according to the invention then plays the role of an inerting agent of the carbonaceous materials.

Preferably, the carbonaceous materials comprise active carbon.

Preferably, the hydrophobic end group comprises or is constituted by one or more alkyleneoxy groups carrying at least three carbon atoms. Preferably, each hydrophobic end group comprises at least one propylene oxide (propyleneoxy) or butylene oxide group (butyleneoxy), preferably a propyleneoxy group.

At least one of the hydrophobic end groups may comprise at least one amine function. Preferably, each hydrophobic end group comprises an amine function. By way of example, when the hydrophobic end group comprises one or more alkyleneoxy groups, the amine group may be carried by the alkyleneoxy group which is the most distant from the intermediary hydrophilic group.

Preferably, the intermediary hydrophilic group comprises at least one ethylene oxide group (ethyleneoxy).

According to an embodiment of the invention, the hydrophobic end groups comprise a succession of first monomers and the intermediary hydrophilic group comprises a succession of second monomers. According to an embodiment of the invention, the first monomer has a base of propylene oxide. Preferably, the first monomer is a propyleneoxy group. According to an embodiment of the invention, the second monomer has a base of ethylene oxide. Preferably, the second monomer is an ethyleneoxy group. According to an embodiment of the invention, the polymer is a three-block copolymer.

According to an embodiment of the invention, the polymer comprises at least one chain successively comprising a first hydrophobic block comprising a succession of at least two first monomers, a second hydrophilic block comprising a succession of at least two second monomers and a third hydrophobic block comprising at least a succession of at least two monomers optionally identical to the first monomer, the first and third blocks being located at the ends of the chain.

According to an embodiment of the invention, the polymer is linear.

Advantageously, the hydrophobic end groups correspond to more than 50% by mass percentage relative to the mass of the polymer, preferably more than, 60%, advantageously more than 70%.

Preferably, the molecular mass of the polymer is from 1000 g/mol to 3000 g/mol, preferably from 1500 g/mol to 2500 g/mol, more preferably approximately 2000 g/mol.

According to an embodiment, the polymer is water-soluble.

The polymer according to the invention may be obtained by any typical production process of block polymers.

According to an embodiment of the invention, the admixture further comprises a supplementary polymer which is different to the said polymer, the said supplementary polymer being adapted to at least partially neutralise the carbonated materials.

According to an embodiment of the invention, the supplementary polymer comprises at least one chain having hydrophilic end groups and an intermediary hydrophobic group between the hydrophilic end groups.

According to an embodiment of the invention, the hydrophilic end groups comprise a succession of third monomers and the intermediary hydrophobic group comprises a succession of fourth monomers. According to an embodiment of the invention, the third monomer has a base of ethylene oxide. Preferably, the third monomer is an ethyleneoxy group. According to an embodiment of the invention, the fourth monomer has a base of propylene oxide. Preferably, the fourth monomer is a propyleneoxy group. According to an embodiment of the invention, the supplementary polymer is a three-block copolymer.

According to an embodiment of the invention, the supplementary polymer comprises at least one chain successively comprising a fourth hydrophilic block comprising a succession of at least two third monomers, a fifth hydrophobic block comprising a succession of at least two fourth monomers and a sixth hydrophilic block comprising at least a succession of at least two monomers which are optionally identical to the third monomer, the fourth and sixth blocks being located at the ends of the chain.

According to an embodiment of the invention, the supplementary polymer is linear.

Advantageously, the intermediary hydrophobic group of the supplementary polymer corresponds to more than 50% by mass percentage relative to the mass of the supplementary polymer, preferably more than 60%, advantageously more than 70%.

Preferably, the molecular mass of the supplementary polymer is from 7000 g/mol to 9000 g/mol, preferably from 7500 g/mol to 8500 g/mol, more preferably approximately 8000 g/mol.

According to an embodiment, the supplementary polymer is water soluble.

According to an embodiment, the constituent comprises fly ash.

According to an embodiment, the constituent comprises a hydraulic binder.

According to an embodiment of the invention, the hydraulic binder comprises Portland cement.

According to an embodiment of the invention, the hydraulic binder further comprises fly ash.

According to an embodiment, the constituent comprises cement kiln dust.

According to an embodiment, the constituent corresponds to the hydraulic composition.

According to an embodiment, the decrease of the air content of the hydraulic composition thirty minutes after mixing of the hydraulic binder, the air-entraining agent and the water is less than 3%.

The present invention also relates to a process for treatment of at least one constituent of a hydraulic composition comprising at least one air-entraining agent, said constituent being able to correspond to the hydraulic composition, said constituent comprising carbonaceous materials, in particular active carbon comprising the addition to the said constituent of at least one admixture comprising at least one polymer comprising at least one chain having hydrophobic end groups and an intermediary hydrophilic group between the hydrophobic end groups, the admixture being adapted to at least partially neutralise the carbonaceous materials.

According to an embodiment, the process comprises:
obtaining the measurement of a representative value of the absorption of the probe molecules by the carbonaceous materials of a sample of said constituent; and
production of the hydraulic composition with a quantity of admixture which depends on the said value.

According to an embodiment, the process comprises the mixing of the admixture and the constituent.

The present invention also relates to a production line of a hydraulic composition comprising at least one air-entraining agent and at least one constituent comprising carbonaceous materials, in particular active carbon or unburned carbon. The production line comprises:
means to withdraw at least one sample of the constituent;
means to measure a representative value of the absorption of the probe molecules by the carbonaceous materials of the sample of the constituent; and
means to produce the hydraulic composition with a quantity of the admixture which depends on the said value.

According to an embodiment, the probe molecules may be a dye. The dye may be any molecule which is soluble in a solution, adapted to provide colour to the solution and be adsorbable by the carbonaceous materials. By way of example, the dye is included in the group comprising methylene blue, acridine, safranine, thioflavine, bromophenol blue, alizarin red S, methyl blue, Eriochrome black T, malachite green, phenol red, methyl violet, toluoylene red (or neutral red), lycopene and tartrazine. Preferably, the dye is methylene blue.

According to an embodiment, the measurement of the methylene blue value is carried out according to the NF EN 933-9 Standard.

According to an embodiment, the measurement of the methylene blue value comprises an automated measurement of the methylene blue value in an aqueous solution and/or an automated measurement of the methylene blue value in a mix of water and di-ethylene glycol.

According to a particular embodiment, the mixing of the constituent with the admixture is carried out before and/or after the withdrawal of the sample of the constituent.

According to a particular embodiment, the above-mentioned process comprises the homogenisation and/or screening and/or dividing and/or drying of the sample of the constituent, before measurement of the methylene blue value.

According to a particular embodiment, the measurement of the methylene blue value comprises:
mixing the sample of the constituent with a solution to form a dispersion;
injecting one single dose of methylene blue into the dispersion;
separating the dispersion into particles and a liquid fraction; and
measuring in the liquid fraction the quantity of excess methylene blue which has not reacted with the sample of the constituent.

According to a particular embodiment, the said separation is carried out by filtering and/or by sedimentation by the addition of a flocculating agent.

According to a particular embodiment, the determination of the quantity of methylene blue which has not reacted is carried out by a measurement of the absorbance and/or transmittance.

According to a particular embodiment, the said absorbance and/or transmittance measurement is carried out in a spectrophotometric cell or using a phototrode.

According to a particular embodiment, the said absorbance and/or transmittance measurement is carried out at a wave length from 640 to 680 nm and preferably 660 nm.

### EXAMPLES

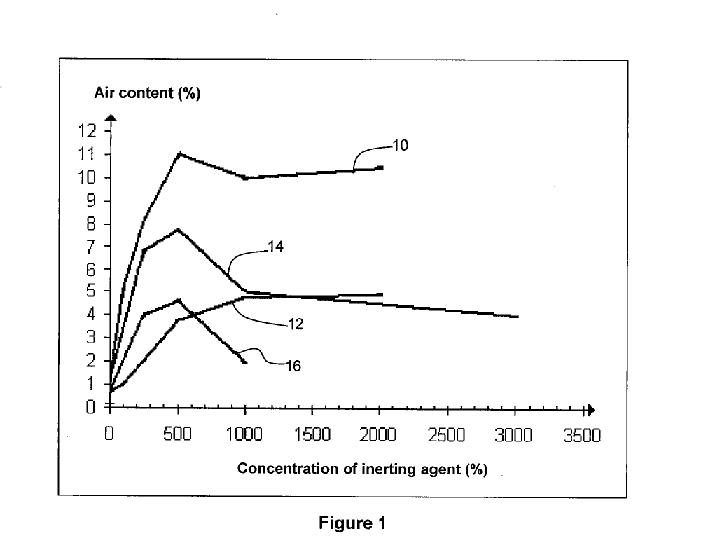

The invention is described herein below in more detail using the following examples relative to FIG. 1 which represents the curves of the initial air content of mortars according to concentrations of an inerting agent.

For the remainder of the description, when the proportion of an admixture is expressed in parts per million (ppm), this means a milligramme of dry extract of admixture per kilogramme of hydraulic binder, the hydraulic binder comprising the cement and optionally fly ash and the active carbon. Unless otherwise specified the percentages correspond to mass percentages.

Formulation of Mortar with Fly Ash

The formulation (1) of mortar with fly ash used to carry out the tests is described in Table 1 below:

TABLE 1
Formulation (1) of mortar with fly ash

| | Proportion |
|---|---|
| Component | (in grams) |
| Portland cement | 0.7*808.8-0.7*X |
| 0/4 mm sand | 2700 |
| Fly ash | 0.3*808.8-0.3*X |
| Active carbon | X (varying between 0.1 and 2% |
| | by mass relative to the mass of |
| | binder) |
| Mixing water | 505 |
| AEA | 100 ppm relative to the mass of |
| | binder |

The Portland cement is a cement produced by Lafarge at the cement plant of Le Havre. It is a CEM I 52.5 PMES cement.

The mixing water/cement ratio is 0.496. The hydraulic binder, or binder, corresponds to the mix comprising the Portland cement, the fly ash and the active carbon.

Formulation of Mortar without Fly Ash

The formulation (2) of mortar without fly ash used to carry out the tests is described in Table 2 below:

TABLE 2
Formulation (2) of mortar without fly ash

| | Proportion |
|---|---|
| Component | (in grams) |
| Portland cement | 808.8 |
| 0/4 mm sand | 2700 |
| Mixing water | 505 |

The Portland cement is a cement produced by Lafarge at the cement plant of Le Havre. It is a CEM I 52.5 PMES cement. The mixing water/cement ratio is 0.496.

Preparation Method of the Mortar

The mortar according to formulation (1) or (2) is carried out using a mixer of the Perrier type. The entire operation is carried out at 20° C. The preparation method comprises the following steps:
Put the sands in the mixer vessel;
At T=0 second: begin mixing at low speed (140 rpm) and simultaneously add the wetting water in 30 seconds, then continue to mix at low speed (140 rpm) until 60 seconds;
At T=1 minute: stop the mixing and let rest for 4 minutes;
At T=5 minutes: (this time corresponds to T0 for the measurements) add the hydraulic binder;
At T=6 minutes: mix for 1 minute at low speed (140 rpm);
At T=7 minutes: add the mixing water in 30 seconds (whilst continuing to mix at low speed (140 rpm)); and
At T=7 minutes and 30 seconds: mix for 1 minute at high speed (300 rpm).

Formulations of Concrete

The formulation (3) of concrete used to carry out the tests is described in Table 3 below:

TABLE 3
Formulation (3) of concrete

| | Proportion (in kilogram per |
|---|---|
| Component | m³ of fresh concrete) |
| Binder | 350 |
| 0/5 mm sand | 711 |
| 4/10 mm gravel | 308 |
| 10/20 mm gravel | 763 |
| AEA | 120 à 240 ppm |
| Water | 162 |
| Active carbon | 1.75 |

The hydraulic binder comprises 70% of Portland cement from Lafarge-Le Havre and 30% of fly ash produced on the site of Will County (Fly ash of class C). The water/cement ratio is 0.45. The air-entraining agent (AEA) is the product commercialised under the brand name of MICRO-AIR™ 104 by BASF.

The formulation (4) of concrete used to carry out the tests is described in Table 4 below:

TABLE 4
Formulation (4) of concrete

| | Proportion (in kilogram per |
|---|---|
| Component | m³ of fresh concrete) |
| Cement | 245.4 |
| Fly ash | 61.1 |
| 0/5 mm sand | 688.2 |
| 4/10 mm gravel | 296.7 |
| 10/20 mm gravel | 735.7 |
| Water-reducing agent | 0.83 |
| Water | 158.4 |

The cement is a Portland cement from Lafarge-Le Havre. The 0/5 sand, the 5/10 gravel and the 10/20 gravel come from the site of Saint-Bonnet. The plasticizer is the product commercialised under the brand name of Pozzolith 200 N by BASF.

Preparation Method of Concrete

The concrete according to formulation (3) or (4) is produced using a B165 Altrad concrete mixer equipped with a geared motor. The volume of concrete in each batch is 30 L. The entire operation is carried out at 20° C. The preparation method comprises the following steps:
Introduce the AEA and 80% of the water into the concrete mixer;
Put the aggregates in the concrete mixer;
At T=0 second: begin the mixing at 15 rpm;
At T=3 minutes: add the hydraulic binder (cement and fly ash) (this time corresponds to T0 for the measurements) and mix for 1 minute at 15 rpm;
At T=4 minutes: add 20% of the water (mixing water) and mix for 3 minutes at 15 rpm.

Measurement Method of the Spread/Slump of a Concrete

The method used corresponds to the method specified in the NF P 18-451 Standard, 1981. The truncated measurement cone for concrete corresponds to the one defined in the same NF P 18-451 Standard, 1981.

The principle of the spread/slump measurement consists of filling a spread/slump measurement cone with the concrete to be tested, then releasing the concrete from the spread/slump measurement cone in order to determine, for the slump measurement, the height of the slump, and, for the spread measurement, the surface of the obtained disk when the concrete has finished spreading.

Measurement Method of the Spread/Slump of a Mortar

The truncated measurement cone for mortar corresponds to a reproduction at the scale ½ of the cone as defined by the NF P 18-451 Standard, 1981. The truncated spread measurement cone has the following dimensions:
top diameter: 50+/−0.5 mm;
bottom diameter: 100+/−0.5 mm; and
height: 150+/−0.5 mm.

The entire operation is carried out at 20° C. The spread/slump measurement is carried out as described below:
Fill the cone with the mortar to be tested in one single operation;
If necessary, tap the mortar to homogenously distribute it in the cone;
Level the top surface of the cone;
Lift the cone vertically; and
Measure the slump +/−1 mm at the highest point and/or measure the spread according to four diameters at 45° with a calliper square. The result of the spread measurement is the average of the four values, +/−1 mm.

Measurement Method of the Air Content of a Mortar

This is a standardized test described in the NF EN 1015-7 Standard.

The measurement method comprises the following steps:
Fill an aerometer having a capacity of 0.75 L with mortar;
Close the aerometer;
Compress the air contained in the mortar using a piston until reaching a specific pressure;
Determine the volume; and
Deduce the volume of air contained in the mortar.

The air content of the mortar is expressed in percentage of voids relative to the volume of the mortar. In the following description, the initial air content of the mortar is the air content measured 10 minutes after T0 in the preparation method of the mortar and the final air content of the mortar is the air content measured 30 minutes after T0.

Measurement Method of the Air Content of a Concrete

The air content of a concrete is measured by the compressibility method described in the NF EN 13250-7 Standard. The air content of the concrete is expressed in percentage of voids relative to the volume of the concrete. In the following description, the initial air content of the concrete is the air content measured 10 minutes after T0 in the preparation method of the concrete and the final air content of the concrete is the air content measured 60 minutes after T0.

Measurement Method of the Density of a Mortar

The measurement of the density is carried out by weighing a known volume of mortar. In the following description, the initial density is the density measured 7 minutes after T0 in the preparation method of the mortar and the final density is the density measured 28 minutes after T0.

### Example 1

In Example 1, mortars according to formulation (1) were produced using fly ash produced on the site of Will County and using the active carbon commercialised under the brand name of GLZ50 by Norit. The GLZ50 active carbon has a BET specific surface of 515 m²/g. In tests (a) to (n) hereinafter, the contents of GLZ50 are given in mass percentage relative to the mass of binder and the contents of the inerting agent are given in parts per millions (ppm) relative to the mass of binder. The air-entraining agent (AEA) is the product commercialised under the brand name of MICRO-AIR™ 104 by BASF.

For each of the tests (a) to (n) a mortar according to formulation (1) and/or a mortar according to formulation (2) were produced in the following conditions:

(a) absence of active carbon and absence of inerting agent;

(b) addition of 0.5% of the GLZ50 active carbon and absence of inerting agent;

(c) addition of 0.5% of the GLZ50 active carbon and addition of 1000 ppm of the inerting agent commercialised under the brand name of ABIL™ Care 85 by Evonik. The ABIL™ Care 85 inerting agent is an ethoxylated silicone;

(d) addition of 0.5% of the GLZ50 active carbon and addition of 1000 ppm of the inerting agent commercialised under the brand name of PEG 200 by Fluka. The PEG 200 inerting agent is poly ethylene oxide;

(e) addition of 0.5% of the GLZ50 active carbon and addition of 1000 ppm of the inerting agent commercialised under the brand name of PEG 2000 by Fluka. The PEG 2000 inerting agent is a polyethylene oxide;

(f) addition of 0.5% of the GLZ50 active carbon and addition of 1000 ppm of the inerting agent commercialised under the brand name of PEG 17500 by Fluka. The PEG 17500 inerting agent is a polyethylene oxide;

(g) addition of 0.5% of the GLZ50 active carbon and addition of 1000 ppm of the PEG 1100 polymethacrylate inerting agent with a molar mass of approximately 20000 g/mol which is a polymethacrylate with side chains of polyethylene oxide. It is called pmeta PEG 1100 in Table 5;

(h) addition of 0.5% of the GLZ50 active carbon and addition of 1000 ppm of the inerting agent commercialised under the brand name of DP/GJ 2388 by SNF Floerger. The DP/GJ 2388 inerting agent is a terpolymer, ⅓ styrene, ⅓ methacrylate and ⅓ MPEG;

(i) addition of 0.5% of the GLZ50 active carbon and addition of 500 ppm of the inerting agent commercialised under the brand name of Agnique SBO-10 by Cognis. The Agnique SBO-10 inerting agent is an ethoxylated triglyceride;

(j) addition of 0.5% of the GLZ50 active carbon and addition of 1000 ppm of the inerting agent commercialised under the brand name of 2-phenoxyethanol by Fluka;

(k) addition of 0.5% of the GLZ50 active carbon and addition of 500 ppm of the inerting agent commercialised under the brand name of Pluronic™ RPE 1720 by BASF. The Pluronic™ RPE 1720 inerting agent is a three-block polymer of the PO/EO/PO type (poly propylene oxide/poly ethylene oxide/poly propylene oxide) comprising a 20% content of ethylene oxide and 2150 g/mol molecular weight;

(l) addition of 0.5% of the GLZ50 active carbon and addition of 1000 ppm of the inerting agent commercialised under the brand name of Pluronic™ RPE 1740 by BASF. The Pluronic™ RPE 1740 inerting agent is a three-block polymer of the PO/EO/PO type (poly propylene oxide/poly ethylene oxide/poly propylene oxide) comprising a 40% content of ethylene oxide and 2650 g/mol molecular weight;

(m) addition of 0.5% of the GLZ50 active carbon and addition of 1000 ppm of a three-block polymer of the EO/PO/EO type (poly ethylene oxide/poly propylene oxide/poly ethylene oxide) comprising a 10% content of propylene oxide and 1000 g/mol molecular weight. This product is commercialised by Aldrich. It is called PE 1010 in Table 5; and

(n) addition of 0.5% of the GLZ50 active carbon and addition of 500 ppm of the inerting agent commercialised under the brand name of Pluronic™ PE 6800 by BASF. The Pluronic™ PE 6800 inerting agent is a three-block polymer of the EO/PO/EO type (poly ethylene oxide/poly propylene oxide/poly ethylene oxide) comprising an 80% content of propylene oxide % and 8000 g/mol molecular weight.

The initial and final air contents were measured for each mortar. The results are grouped together in Table 5 below. The dosages were selected at the optimum efficiency level.

TABLE 5

| | | Mortar formulation | | Mortar formulation | |
|---|---|---|---|---|---|
| | | (1) with AEA | | (2) without AEA | |
| | | Initial | Final | Initial | Final |
| | | air con- | air con- | air con- | air con- |
| Test | Inerting agent | tent (%) | tent (%) | tent (%) | tent (%) |
| (a) | No inerting agent | 11 | 10.8 | 5.2 | 5.6 |
| | (without active carbon) | | | | |
| (b) | No inerting agent | 1.2 | — | — | — |
| | (with active carbon) | | | | |
| (c) | ABIL ™ Care 85 | 6.6 | 5.2 | 3 | 2.5 |
| (d) | PEG 200 | 4.5 | 1.5 | 7 | 3 |
| (e) | PEG 2000 | 11.5 | 7.5 | 6.8 | 4 |
| (f) | PEG 17500 | 8.6 | 9.4 | 11 | 8 |
| (g) | pmeta PEG 1100 | 6 | 5.9 | 8.2 | 5.3 |
| (h) | DP/GJ 2388 | 10.5 | 7.3 | 8 | 3 |
| (i) | Agnique SBO-10 | 7.7 | 6.8 | 5 | 3 |
| | (500 ppm) | | | | |
| (j) | 2-phenoxyethanol | 8 | 4.6 | 6.4 | 4.9 |
| (k) | Pluronic ™ RPE 1720 | 11 | 10.4 | 5.6 | 3.25 |
| | (500 ppm) | | | | |
| (l) | Pluronic ™ RPE 1740 | 8 | 7.5 | 5.8 | 2.8 |
| (m) | PE 1010 | 19 | 18.5 | 16 | 17.7 |
| (n) | Pluronic ™ PE 6800 | 18 | 17 | 15.2 | 11 |

In the absence of active carbon (test (a)), the initial air content is 11% and the final air content is 10.8%.

The PEG 2000, SBO-10, Pluronic™ RPE 1720 and Pluronic™ RPE 1740 inerting agents make it possible to reach an air content at 30 minutes greater than 6% in formulation (1) and entrain an additional initial absorption of air less than 2% in formulation (2). However, the stability of the entrained air in formulation (1) is better for the SBO-10, Pluronic™ RPE 1720 and Pluronic™ RPE 1740 inerting agents (variation of the air content less than 1%) than the PEG 2000 inerting agent (variation of the air content greater than 4%).

The ABIL™ Care 85, PEG 200, pmeta PEG 1100, 2-phenoxyethanol inerting agents are not satisfactory inasmuch as they do not make it possible to reach a final air content greater than 6% in formulation (1).

The PEG 17500, pmeta PEG 1100, DP/GJ 2388, PE 1010 and Pluronic™ PE 6800 inerting agents are not satisfactory inasmuch as they do not entrain an additional absorption of initial air greater than 2% in formulation (2).

### Example 2

Mortars according to formulation (1) were produced using fly ash from Will County, 0.5% of the GLZ50 active carbon and 100 ppm of an AEA and adding the Pluronic™ RPE 1720 inerting agent in different quantities. The air-entraining agent (AEA) is the product commercialised under the brand name of MICRO-AIR™ 104 by BASF. In at least certain mortars, the spread at 5 and 25 minutes, the initial and final air contents and the initial and final densities were measured. The results are grouped together in Table 6 below.

TABLE 6

| | Concentration of Pluronic ™ RPE 1720 (ppm) | | | | | | | |
|---|---|---|---|---|---|---|---|---|
| | 0 | 100 | 250 | 500 | 1000 | 2000 | 3000 | 5000 |
| Spread at 5 min (mm) | 227.5 | 245 | 240 | 235 | 245 | 250 | 250 | 250 |
| Initial air content (%) | 1.2 | 5.2 | 8.1 | 11 | 10 | 10.4 | — | — |
| Initial density (g/L) | 2223.2 | 2160 | 2083.2 | 2006 | 2050 | 2056.5 | — | — |
| Spread at 25 min (mm) | — | — | — | — | 220 | — | — | — |
| Final air content (%) | — | — | — | 10.4 | 7.4 | — | — | — |
| Final density (g/L) | — | — | — | — | 2240 | — | — | — |

Mortars according to formulation (1) were produced using fly ash from Will County, 0.5% of the GLZ50 active carbon and 100 ppm of an AEA and adding the SBO-10 inerting agent in different quantities. In at least certain mortars, the spread at 5 and 25 minutes, the initial and final air contents and the initial and final densities were measured.

The results are grouped together in 7 below.

TABLE 7

| | Concentration in SBO-10 (ppm) | | | | | | | |
|---|---|---|---|---|---|---|---|---|
| | 0 | 100 | 250 | 500 | 1000 | 2000 | 3000 | 5000 |
| Spread at 5 min (mm) | 227.5 | — | 240 | 245 | 245 | — | 112.5 | 140 |
| Initial air content (%) | 1.2 | — | 6.8 | 7.7 | 5 | — | 4 | 4.4 |
| Initial density (g/L) | 2223.2 | — | 2110 | 2100 | 2160 | — | 2167.2 | 2136.5 |
| Spread at 25 min (mm) | — | — | — | 210 | 210 | — | — | — |
| Final air content (%) | — | — | — | 6.8 | 1.4 | — | — | — |
| Final density (g/L) | — | — | — | 2115 | 2250 | — | — | — |

The SBO-10 inerting agent has the disadvantage of inducing a considerable decrease of the spread of the mortar at 5 min for concentrations greater than 3000 ppm. Furthermore, the obtained initial and final air contents are less than those obtained using the Pluronic™ RPE 1720 inerting agent.

FIG. 1 represents:
the curve 10 of the initial air content of the mortar relative to the concentration of Pluronic™ RPE 1720 for the previously described mortar;
the curve 12 of the initial air content of the mortar relative to the concentration of Pluronic™ RPE 1720 for the previously described mortar the difference being that it does not comprise an AEA;
the curve 14 of the initial air content of the mortar relative to the concentration of SBO-10 for the previously described mortar; and
the curve 16 of the initial air content of the mortar relative to the concentration of SBO-10 for the previously described mortar the difference being that it does not comprise an AEA.

The initial air content for the SBO-10 inerting agent reaches an optimum for a concentration of inerting agent of the order of 500 ppm, then it drops until reaching a value of 4 to 5%. The initial air content for the Pluronic™ RPE 1720 inerting agent, increases with the concentration of inerting agent and reaches a plateau at approximately 10%, for a concentration of inerting agent beginning at 500 ppm. It is advantageous to use the Pluronic™ RPE 1720 inerting agent because the content remains substantially constant for concentrations of inerting agent greater than 500 ppm, whilst it varies more considerably for the SBO-10 inerting agent.

### Example 3

Mortars according to formulation (1) were produced using fly ash from Will County, different concentrations of the GLZ50 active carbon and 100 ppm of an AEA and adding the Pluronic™ RPE 1720 inerting agent in different quantities. The air-entraining agent (AEA) is the product commercialised under the brand name of MICRO-AIR™ 104 by BASF. The initial air content was measured for each mortar. The results are grouped together in Table 8 below.

TABLE 8
Mortar with AEA

| | Concentration of Pluronic ™ RPE 1720 (ppm) | | | | | | |
|---|---|---|---|---|---|---|---|
| | 0 | 100 | 250 | 500 | 1000 | 1500 | 2000 |
| Initial air content with | 1.2 | 5.2 | 8.1 | 11 | 10 | — | 10.4 |
| 0.5% of GLZ50 (%) | | | | | | | |
| Initial air content with | 1.4 | — | — | 7.4 | 10 | — | — |
| 1% of GLZ50 (%) | | | | | | | |
| Initial air content with | 1.2 | — | — | — | 8.5 | 10.5 | — |
| 1.5% of GLZ50 (%) | | | | | | | |

Mortars according to formulation (1) were produced using fly ash from Will County, different concentrations of the GLZ50 active carbon and adding the Pluronic™ RPE 1720 inerting agent in different quantities and in the absence of an AEA. The initial air content was measured for each mortar. The results are grouped together in Table 9 below.

TABLE 9
Mortar without AEA

| | Concentration of Pluronic ™ RPE 1720 (ppm) | | | | | | |
|---|---|---|---|---|---|---|---|
| | 0 | 100 | 250 | 500 | 1000 | 1500 | 2000 |
| Initial air content with | 0.7 | 1 | — | 3.8 | 4.8 | — | 4.9 |
| 0.5% of GLZ50 (%) | | | | | | | |
| Initial air content with | 0.7 | — | — | 2.2 | 4.5 | — | — |
| 1% of GLZ50 (%) | | | | | | | |
| Initial air content with | 0.7 | — | — | — | 2.2 | 4 | — |
| 1.5% of GLZ50 (%) | | | | | | | |

Whatever the concentration of active carbon, the initial air content increases until reaching a plateau of approximately 10% for a mortar comprising 100 ppm of AEA and of approximately 5% for a mortar not comprising an AEA. The Pluronic™ RPE 1720 inerting agent therefore makes it possible to reach an air content at a constant level, which depends on the concentration of AEA whatever the concentration of active carbon.

### Example 4

A mortar according to formulation (1) was produced using fly ash from Will County, 0.5% of active carbon commercialised under the brand name of CPAC by Albemarle, 100 ppm of AEA and 500 ppm of Pluronic™ RPE 1720. The air-entraining agent (AEA) is the product commercialised under the brand name of MICRO-AIR™ 104 by BASF. The initial and final air contents were measured.

A mortar according to formulation (1) was produced using fly ash from Will County, 0.5% of the GLZ50 active carbon, 100 ppm of AEA and 500 ppm of Pluronic™ RPE 1720. The initial and final air contents were measured.

A mortar according to formulation (1) was produced using fly ash from the Fisk site, containing active carbon, 100 ppm of AEA and 500 ppm of Pluronic™ RPE 1720. The initial and final air contents were measured.

The results are grouped together in Table 10 below.

TABLE 10
Mortar with AEA

| | Initial air | Final air |
|---|---|---|
| Inerting agent | content (%) | content (%) |
| RPE (500 ppm) - GLZ50 0.5% | 11 | 10.4 |
| RPE (500 ppm) - CPAC 0.5% | 13 | 11.5 |
| RPE (700 ppm) - Fisk | 11.2 | 9 |

Advantageously, the initial air contents are substantially identical for the different fly ash/active carbon. Furthermore, the variation of the air content over time is less than 3% for the different fly ash/active carbon.

### Example 5

Concretes according to formulation (3) were produced using fly ash from Will County, the GLZ50 active carbon and the Pluronic™ RPE 1720 inerting agent. The air-entraining agent (AEA) is the product commercialised under the brand name of MICRO-AIR™ 104 by BASF. The initial and final air contents were measured for the concrete. The concrete was mixed in a drum mixer at 2 rpm at the end of the production process of the concrete, and until making the measurements. The results are grouped together in Table 11 below.

TABLE 11
Concretes

| | | | Air con- | Air con- |
|---|---|---|---|---|
| | | Pluronic ™ | tent at | tent at |
| | AEA | RPE | 10 min | 60 min |
| | (ppm) | 1720 (ppm) | (%) | (%) |
| No AC/120 ppm AEA/no | 120 | 0 | 6.6 | 7 |
| inerting agent | | | | |
| 0.5% AC/120 ppm AEA/ | 120 | 0 | 2.9 | 2.3 |
| no inerting agent | | | | |
| 0.5% AC/120 ppm AEA/ | 120 | 3000 | 4.8 | 4.4 |
| 3000 ppm RPE | | | | |

The use of the inerting admixture according to the invention makes it possible to obtain an initial air content of the order of 5%.

### Example 6

A mortar according to formulation (2) was produced without active carbon and with 50 ppm of AEA. The air-entraining agent (AEA) is the product commercialised under the brand name of MICRO-AIR™ 104 by BASF.

A mortar according to formulation (2) was produced without active carbon and without an AEA.

A mortar according to formulation (2) was produced with 50 ppm of AEA and with 0.5% of the GLZ50 active carbon.

A mortar according to formulation (2) was produced with 50 ppm of AEA, with 0.5% of the GLZ50 active carbon and 500 ppm of Pluronic™ RPE 1720. The initial and final air contents were measured for each mortar.

The results are grouped together in Table 12 below.

TABLE 12
Mortar without fly ash

| | Initial air | Final air |
|---|---|---|
| | content (%) | content (%) |
| Mortar without active carbon, | 13 | 14.2 |
| with an AEA, without an inerting | | |
| agent | | |
| Mortar without active carbon | 5.2 | 5.6 |
| without an AEA, without an | | |
| inerting agent | | |
| Mortar with 0.5% GLZ50, with | 2.1 | 2.1 |
| an AEA, without an inerting | | |
| agent | | |
| Mortar with 0.5% GLZ50, with | 15.5 | 14.5 |
| an AEA, with | | |
| Pluronic ™ RPE 1720 (500 ppm) | | |

The mortar without active carbon and without an AEA contains approximately 5.5% of naturally occluded air. The use of 50 ppm of AEA by mass of cement makes it possible to obtain approximately 14% of entrained air after 30 minutes. Pollution by 0.5% of GLZ50 by mass of cement makes the air content drop to 2%. The addition of 500 ppm of Pluronic™ RPE 1720 by mass of cement makes the air content increase to 14.5% at 30 minutes. The Pluronic™ RPE 1720 inerting agent therefore makes it possible to neutralise the active carbon in a mortar polluted by active carbon, by increasing the air content to the level of the air content of a mortar not polluted by active carbon and ensuring the stability of the air content for 30 minutes.

### Example 7

Mortars were produced using another air-entraining agent than the MICRO-AIR™ 104.

A mortar according to formulation (1) was produced using fly ash from Will County, without active carbon and 50 ppm of AEA. The air-entraining agent (AEA) is the product commercialised under the brand name of DDBS by Sigma-Aldrich. It is sodium dodecylbenzene sulfonate.

A mortar according to formulation (1) was produced using fly ash from Will County, 0.5% of the GLZ50 active carbon and 50 ppm of DDBS.

A mortar according to formulation (1) was produced using fly ash from Will County, 0.5% of the GLZ50 active carbon, 50 ppm of DDBS and 500 ppm of Pluronic™ RPE 1720.

The air contents were measured for each mortar at 5 minutes and at 60 minutes. The results are grouped together in Table 13 below.

TABLE 13

| | Air content | Air content |
|---|---|---|
| | after 5 min | after 60 min |
| | (%) | (%) |
| Mortar without active carbon, | 13 | 14.2 |
| with an AEA, without an inerting | | |
| agent | | |
| Mortar with 0.5% GLZ50, with | 2.1 | 2.1 |
| an AEA, without an inerting | | |
| agent | | |
| Mortar with 0.5% GLZ50, with | 15.5 | 14.5 |
| an AEA, with | | |
| Pluronic ™ RPE 1720 (500 ppm) | | |

The mortar without active carbon and with 50 ppm of DDBS makes it possible to obtain approximately 14% of entrained air after 60 minutes. Pollution by 0.5% of GLZ50 by mass of cement makes the air content drop to 2%. The addition of 500 ppm of Pluronic™ RPE 1720 by mass of cement makes the air content increase to 14.5% at 60 minutes. The Pluronic™ RPE 1720 inerting agent therefore makes it possible to neutralise the active carbon in the mortar polluted by the active carbon said mortar comprising the air-entraining agent DDBS.

A mortar according to formulation (1) was produced using fly ash from Fisk which comprises active carbon and 100 ppm of an AEA. The air-entraining agent (AEA) is the product commercialised under the brand name of Micro Air™ by BASF (a different product from the previously described MICRO-AIR™ 104 air-entraining agent). It is an air-entraining agent from a derivative of wood.

A mortar according to formulation (1) was produced using fly ash from Fisk and 750 ppm of Micro Air™

A mortar according to formulation (1) was produced using fly ash from Fisk, 100 ppm of Micro Air™ and 500 ppm of Pluronic™ RPE 1720.

The air contents were measured for each mortar at 5 minutes and at 60 minutes. The results are grouped together in Table 14 below.

TABLE 14

| | Air content | Air content |
|---|---|---|
| | after 5 min | after 60 min |
| | (%) | (%) |
| Mortar with 100 ppm of an AEA, | 2 | 0 |
| without an inerting agent | | |
| Mortar with 750 ppm of an AEA, | 8.4 | 8.5 |
| without an inerting agent | | |
| Mortar with 100 ppm of an AEA, | 10 | 7 |
| and with Pluronic ™ RPE 1720 | | |
| (500 ppm) | | |

The use of 750 ppm of an AEA by mass of cement makes it possible to obtain approximately 8.5% of entrained air after 60 minutes. The use of only 100 ppm of an AEA by mass of cement does not make it possible to obtain entrained air after 60 minutes. The addition of 500 ppm of Pluronic™ RPE 1720 by mass of cement makes the air content increase to 7% at 60 minutes. The Pluronic™ RPE 1720 inerting agent therefore makes it possible to neutralise the active carbon in a mortar polluted by active carbon, said mortar comprising the air-entraining agent Micro Air™.

### Example 8

In the tests (o) to (w) hereinafter, a mortar according to formulation (1) was made using fly ash from Fisk, containing active carbon, 100 ppm of Micro Air™ and 250 ppm of Pluronic™ RPE 1720. According to the tests (o) to (v), the following were further added simultaneously to the Pluronic™ RPE 1720:

(o) addition of 250 ppm de Pluronic™ RPE 1720 (i.e. 500 ppm of Pluronic™ RPE 1720 in total);

(p) addition of 250 ppm of the PEG 17500 inerting agent;

(q) addition of 250 ppm of the PE 1010 inerting agent;

(r) addition of 250 ppm of the Pluronic™ PE 6800 inerting agent;

(s) addition of 250 ppm of the DP/GJ inerting agent;

(t) addition of 250 ppm of the inerting agent commercialised under the brand name of EGPE by Sigma-Aldrich. It is an ethylene glycol phenyl ether;

(u) addition of 250 ppm of the inerting agent corresponding to an acrylate polymer, comprising 100% of side chains of the polyethylene glycol type;

(v) addition of 250 ppm of the inerting agent corresponding to an acrylate polymer, comprising 70% of side chains of the polyethylene glycol type; and

(w) addition of 250 ppm of the inerting agent corresponding to an acrylate polymer, comprising 70% of side chains of the polyethylene glycol type.

The air contents at 5 minutes and at 60 minutes were measured for each mortar. The results are grouped together in Table 15 below.

TABLE 15

| | | Air con- | Air con- |
|---|---|---|---|
| | | tent af- | tent af- |
| | | ter 5 | ter 60 |
| Test | Inerting agent | min (%) | min (%) |
| (o) | Pluronic ™ RPE 1720 (500 ppm) | 9.8 | 7 |
| (p) | Pluronic ™ RPE 1720 (250 ppm) + | 10.5 | 8.4 |
| | PEG 17500 (250 ppm) | | |
| (q) | Pluronic ™ RPE 1720 (250 ppm) + | 10.4 | 8.5 |
| | PE 1010 (250 ppm) | | |
| (r) | Pluronic ™ RPE 1720 (250 ppm) + | 9.7 | 9.8 |
| | Pluronic ™ PE 6800 (250 ppm) | | |
| (s) | Pluronic ™ RPE 1720 (250 ppm) + | 9.4 | 7.8 |
| | DP/GJ (250 ppm) | | |
| (t) | Pluronic ™ RPE 1720 (250 ppm) + | 12 | 10.1 |
| | EGPE (250 ppm) | | |
| (u) | Pluronic ™ RPE 1720 (250 ppm) + | 9.9 | 8.1 |
| | methacrylate polymer, 100% PEG (250 ppm) | | |
| (v) | Pluronic ™ RPE 1720 (250 ppm) + | 8.8 | 7.9 |
| | acrylate polymer, 70% PEG (250 ppm) | | |
| (w) | Pluronic ™ RPE 1720 (250 ppm) + | 9.9 | 7 |
| | acrylate polymer, 100% PEG (250 ppm) | | |

The use of the Pluronic™ PE 6800 inerting agent in addition to the Pluronic™ RPE 1720 inerting agent makes it possible to improve the stability of the entrained air compared to test (o) in which only the Pluronic™ RPE 1720 inerting agent was used.

### Example 9

A mortar according to formulation (1) was made using fly ash from Fisk, containing active carbon, without an AEA and without an inerting agent. The initial and final air contents were measured.

A mortar according to formulation (1) was made using fly ash from Fisk, containing active carbon, 100 ppm of Micro Air™ and adding the Pluronic™ RPE 1720 inerting agent in different quantities. The initial and final air contents were measured.

A mortar according to formulation (1) was made using fly ash from Fisk, 100 ppm of Micro Air™ and adding the inerting agent commercialised under the brand name of Synperonic™ PE 25R2 by Croda. The Synperonic™ PE 25R2 inerting agent is a three-block polymer of the PO/EO/PO type (poly propylene oxide/poly ethylene oxide/poly propylene oxide) comprising a 20% content of ethylene oxide and 3100 g/mol molecular weight. The initial and final air contents were measured.

A mortar according to formulation (1) was made using fly ash from Fisk, 100 ppm of Micro Air™4 and adding the inerting agent commercialised under the brand name of Pluronic™ RPE 1740 by BASF. The Pluronic™ RPE 1740 inerting agent is a three-block polymer of the PO/EO/PO type (poly propylene oxide/poly ethylene oxide/poly propylene oxide) comprising a 40% content of ethylene oxide and 2650 g/mol molecular weight. The initial and final air contents were measured.

A mortar according to formulation (1) was made using fly ash from Fisk, 100 ppm of Micro Air™ and adding the inerting agent hereinafter referred to by the reference RPE 3560. The RPE 3560 inerting agent is a three-block polymer of the PO/EO/PO type (poly propylene oxide/poly ethylene oxide/poly propylene oxide) comprising a 60% content of ethylene oxide and 3500 g/mol molecular weight. The initial and final air contents were measured.

The results are grouped together in Table 16 below.

TABLE 16

| | Air con- | Air con- |
|---|---|---|
| | tent af- | tent af- |
| | ter 10 | ter 60 |
| | min (%) | min (%) |
| Mortar without an AEA and without an inerting | 2.5 | |
| agent | | |
| Mortar with Pluronic ™ RPE 1720 (500 ppm) | 11.9 | 10.5 |
| Mortar with Pluronic ™ RPE 1720 (1000 ppm) | 10 | 6.3 |
| Mortar with Pluronic ™ RPE 1720 (2000 ppm) | 10.1 | 4.8 |
| Mortar with Synperonic ™ PE 25R2 (500 ppm) | 10.1 | 9.1 |
| Mortar with Synperonic ™ PE 25R2 (1000 ppm) | 10.5 | 8.3 |
| Mortar with Synperonic ™ PE 25R2 (2000 ppm) | 7.1 | 6.1 |
| Mortar with Pluronic ™ RPE 1740 (500 ppm) | 11.8 | 10.6 |
| Mortar with Pluronic ™ RPE 1740 (1000 ppm) | 12 | 10.7 |
| Mortar with Pluronic ™ RPE 1740 (2000 ppm) | 12 | 11.1 |
| Mortar with RPE 3560 (500 ppm) | 11 | 9.7 |
| Mortar with RPE 3560 (1000 ppm) | 14.4 | 12.2 |
| Mortar with RPE 3560 (2000 ppm) | 9.9 | 8.7 |

The Pluronic™ RPE 1720, Synperonic™ PE 25R2, Pluronic™ RPE 1740 and RPE 3560 inerting agents allow each one to reach an air content greater than 8% at 60 minutes when they have a concentration of 500 ppm.

The Pluronic™ RPE 1740 inerting agent allows it to reach an air content greater than 10% at 60 minutes for a concentration of 500 ppm, 1000 ppm and 2000 ppm.

### Example 10

A concrete according to formulation (4) was made except for the difference that the fly ash was replaced by cement and by using 70 ppm of the Micro Air™ air-entraining agent, relative to the mass of the cement.

Concretes according to formulation (4) were made using fly ash from Fisk, 70 ppm of the Micro Air™ air-entraining agent relative to the mass of hydraulic binder (cement and fly ash) and variable quantities of Pluronic™ RPE 1740 and Pluronic™ PE 6800.

The initial and final air contents were measured for each concrete at 5 minutes and at 60 minutes.

The results are grouped together in Table 17 below.

TABLE 17

| | Pluronic ™ | Pluronic ™ | | |
|---|---|---|---|---|
| | RPE 1740 (ppm | PE 6800 (ppm | | |
| | relative to | relative to | Air con- | Air con- |
| | the mass of | the mass of | tent af- | tent af- |
| Concrete | hydraulic | hydraulic | ter 5 | ter 60 |
| Formulations | binder) | binder) | min (%) | min (%) |
| Concrete with | 0 | 0 | 5.5 | 5.4 |
| only cement | | | | |
| Concrete | 0 | 0 | 1.3 | 1.4 |
| according to | | | | |
| formulation (4) | | | | |
| Concrete | 1000 | 0 | 5 | 5.2 |
| according to | | | | |
| formulation (4) | | | | |
| Concrete | 750 | 250 | 4.8 | 5.6 |
| according to | | | | |
| formulation (4) | | | | |

In the absence of an inerting agent, the presence of fly ash comprising active carbon results in a decrease of the quantity of entrained air.

The use of the Pluronic™ RPE 1740 inerting agent by itself or in combination with the Pluronic™ PE 6800 inerting agent makes it possible to obtain an air content at 5 minutes close to the air content obtained when fly ash was absent.

### Example 11

Three concretes according to formulation (4) were made using 140 ppm of the Micro Air™ air-entraining agent, relative to the mass of hydraulic binder (cement and fly ash), 375 ppm of Pluronic™ RPE 1720, relative to the mass of hydraulic binder (cement and fly ash) and 125 ppm of Pluronic™ PE 6800, relative to the mass of hydraulic binder (cement and fly ash).

The first concrete was made according to the previously described process for the production of concrete. The inerting agents were added in the pre-wetting water and the air-entraining agent was added in the mixing water.

The second concrete was made according to the previously described process for the production of concrete the difference being that the inerting agents and the air-entraining agent were added in the pre-wetting water.

The third concrete was made according to the previously described process for the production of concrete the difference being that the inerting agents were added as pre-treatment to the fly ash and the air-entraining agent was added in the mixing water.

The air contents were measured for each concrete at 10 minutes and at 60 minutes.

The results are grouped together in Table 18 below.

TABLE 18

| | Air content | Air content |
|---|---|---|
| | after 5 min | after 60 min |
| Process for production of concrete | (%) | (%) |
| Inerting agents in the pre-wetting water | 6.7 | 5.2 |
| and the AEA in the mixing water | | |
| Inerting agents and the AEA in the pre- | 6.6 | 5.6 |
| wetting water | | |
| Pre-treatment of the inerting agents in | 6.4 | 6.3 |
| the fly ash and the AEA in the mixing water | | |

The air contents at 10 minutes and at 60 minutes are substantially independent of the way the inerting agents and the AEA were added.

### Example 12

A mortar according to formulation (2) was made by adding 1000 ppm of the inerting agent commercialised under the brand name of JEFFAMINE™ D-400 by Huntsman. The JEFFAMINE™ D-400 inerting agent is a polypropyleneoxy diamine of formula CH₃CH(NH₂)CH₂[OCH₂CH(CH₃)]_{X}NH₂ where x is equal to 6.1 with an average molecular weight of 430.

A mortar according to formulation (2) was made by adding 1000 ppm of the inerting agent commercialised under the brand name of JEFFAMINE™ EDR-148 by Huntsman. The JEFFAMINE™ EDR-148 inerting agent is a polypolyethyleneoxy diamine of formula NH₂CH₂CH₂[OCH₂CH₂)]₂NH₂ with an average molecular weight of 148.

A mortar according to formulation (2) was made by adding 1000 ppm of the inerting agent commercialised under the brand name of JEFFAMINE™ ED-900 by Huntsman. The JEFFAMINE™ ED-900 inerting agent is a three-block polymer of formula NH₂[CH(CH₃)CH₂O]ₓ[CH₂CH₂O]_{y}[CH₂CH(CH₃)O]_{z}NH₂ where y is equal to 12.5 and the sum of x and z is equal to 6 with an average molecular weight of 900.

The air contents were measured at 5 minutes for the three previous mortars. A mortar according to formulation (1) was made using fly ash from Fisk, containing active carbon, 100 ppm of MICRO-AIR™ 104 and adding 1000 ppm of the JEFFAMINE™ D-400 inerting agent.

A mortar according to formulation (1) was made using fly ash from Fisk, containing active carbon, 100 ppm of MICRO-AIRT™ 104 and adding 1000 ppm of the JEFFAMINE™ EDR-148 inerting agent.

A mortar according to formulation (1) was made using fly ash from Fisk, containing active carbon, 100 ppm of MICRO-AIRT™ 104 and adding 1000 ppm of the JEFFAMINE™ ED-900 inerting agent.

The air contents were measured at 5 minutes and at 60 minutes for the three previous mortars.

The results are grouped together in Table 19 below.

TABLE 19

| | JEFFAMINE ™ | JEFFAMINE ™ | JEFFAMINE ™ | | | |
|---|---|---|---|---|---|---|
| | D-400 | EDR-148 | ED-900 | MICRO-AIR ™ | | |
| | (ppm relative | (ppm relative | (ppm relative | 104 (ppm relative | | |
| Concrete | to the mass of | to the mass of | to the mass of | to the mass of | Air content | Air content |
| Formulations | hydraulic binder) | hydraulic binder) | hydraulic binder) | hydraulic binder) | after 5 min (%) | after 60 min (%) |
| Mortar according to | 1000 | 0 | 0 | 0 | 8.4 | |
| formulation (2) | | | | | | |
| Mortar according to | 0 | 1000 | 0 | 0 | 6.4 | |
| formulation (2) | | | | | | |
| Mortar according to | 0 | 0 | 1000 | 0 | 5.0 | |
| formulation (2) | | | | | | |
| Mortar according to | 1000 | 0 | 0 | 100 | 13.5 | 10.3 |
| formulation (1) | | | | | | |
| Mortar according to | 0 | 1000 | 0 | 100 | 4.1 | 3.6 |
| formulation (1) | | | | | | |
| Mortar according to | 0 | 0 | 1000 | 100 | 9.8 | 9.1 |
| formulation (1) | | | | | | |

The polyethyleneoxy diamines (JEFFAMINE™ EDR-148) have no inerting effect since the air content at 5 minutes decreases when fly ash is present. The polypropyleneoxy diamines (JEFFAMINE™ D-400) have an inerting effect but the entrained air is not very stable and greatly decreases over time. Furthermore, the polypropyleneoxy diamines entrain air by themselves. The JEFFAMINE™ ED-900 three-block copolymer is an efficient inerting agent with stable entrained air and without the copolymer entraining air itself.

1. A method comprising using, as an inerting agent of carbonaceous materials, for treatment of a constituent of a hydraulic composition comprising an air-entraining agent, said constituent comprising the carbonaceous materials, an admixture, comprising a polymer comprising a chain having hydrophobic end groups and an intermediary hydrophilic group between the hydrophobic end groups, the admixture being adapted to at least partially neutralise the carbonaceous materials.

2. The method according to claim 1, wherein the hydrophobic end groups comprise a succession of first monomers and wherein the intermediary hydrophilic group comprises a succession of second monomers.

3. The method according to claim 2, wherein the first monomer has a base of propylene oxide and wherein the second monomer has a base of ethylene oxide.

4. The method according to claim 1, wherein the polymer is a three-block copolymer.

5. The method according to claim 1, wherein the admixture further comprises a supplementary polymer which is different to said polymer, said supplementary polymer being adapted to at least partially neutralise the carbonaceous materials.

6. The method according to claim 5, wherein the supplementary polymer comprises a chain having hydrophilic end groups and an intermediary hydrophobic group between the hydrophilic end groups.

7. The method according to claim 6, wherein the hydrophilic end groups comprise a succession of third monomers and wherein the intermediary hydrophobic group comprises a succession of fourth monomers.

8. The method according to claim 7, wherein the third monomer has a base of ethylene oxide and wherein the fourth monomer has a base of propylene oxide.

9. The method according to claim 5, wherein the supplementary polymer is a three-block copolymer.

10. The method according to claim 1, wherein the constituent comprises fly ash, hydraulic binder or cement kiln dust.

11-13. (canceled)

14. A treatment method comprising treating a constituent of a hydraulic composition comprising an air-entraining agent with an admixture acting as an inerting agent of carbonaceous materials, said constituent comprising the carbonaceous materials, the admixture comprising a polymer comprising a chain having hydrophobic end groups and an intermediary hydrophilic group between the hydrophobic end groups, the admixture being adapted to at least partially neutralise the carbonaceous materials.

15. The method according to claim 14, wherein the hydrophobic end groups comprise a succession of first monomers and wherein the intermediary hydrophilic group comprises a succession of second monomers.

16. The method according to claim 15, wherein the first monomer has a base of propylene oxide and wherein the second monomer has a base of ethylene oxide.

17. The method according to claim 14, wherein the polymer is a three-block copolymer.

18. The method according to claim 14, wherein the admixture further comprises a supplementary polymer which is different to said polymer, said supplementary polymer being adapted to at least partially neutralise the carbonaceous materials.

19. The method according to claim 18, wherein the supplementary polymer comprises a chain having hydrophilic end groups and an intermediary hydrophobic group between the hydrophilic end groups.

20. The method according to claim 19, wherein the hydrophilic end groups comprise a succession of third monomers and wherein the intermediary hydrophobic group comprises a succession of fourth monomers.

21. The method according to claim 20, wherein the third monomer has a base of ethylene oxide and wherein the fourth monomer has a base of propylene oxide.

22. The method according to claim 18, wherein the supplementary polymer is a three-block copolymer.

23. The method according to claim 14, wherein the constituent comprises fly ash, hydraulic binder or cement kiln dust.
